(19) United States
(12) Patent Application Publication
(10) Pub. No.: US 2014/0189449 A1
(43) Pub. Date: Jul. 3, 2014

(54) METHOD AND SYSTEM FOR CHECKING SOFTWARE

(71) Applicants: HYUNDAI MOTOR COMPANY, Seoul (KR); EWHA UNIVERSITY-INDUSTRY COLLABORATION FOUNDATION, Seoul (KR); KIA MOTORS CORPORATION, Seoul (KR)

(72) Inventors: Seung Yeun Jang, Hwaseong (KR); Jung Hoon Oh, Yongin (KR); Jung Suk Oh, Bucheon (KR); Suk Young Rho, Anyang (KR); Sueng Wan Yang, Gunpo (KR); Joo Young Seo, Seoul (KR); Byoung Ju Choi, Seoul (KR)

(73) Assignees: HYUNDAI MOTOR COMPANY, Seoul (KR); EWHA UNIVERSITY-INDUSTRY COLLABORATION FOUNDATION, Seoul (KR); KIA MOTORS CORPORATION, Seoul (KR)

(21) Appl. No.: 13/956,639

(22) Filed: Aug. 1, 2013

(30) Foreign Application Priority Data
Dec. 31, 2012 (KR) 10-2012-0158397

(51) Int. Cl. G06F 11/36; G06F 11/07

(52) U.S. Cl. CPC G06F 11/3648; G06F 11/0727
USPC 714/718

(57) ABSTRACT

A method and a system that checks software and includes a hooking module that collects process control block (PCB) information corresponding to each process on a kernel by being executed at the time of booting a system. In addition, the system includes a safety service module that searches and defends the defects of the process by being inserted into a memory region of the process based on the collected PCB information.

### CROSS-REFERENCE TO RELATED APPLICATION

This application is based on and claims priority from Korean Patent Application No. 10-2012-0158397, filed on Dec. 31, 2012 in the Korean Intellectual Property Office, the disclosure of which is incorporated herein in its entirety by reference.

### BACKGROUND OF THE INVENTION

1. Field of the Invention

The present invention relates to a method and a system for checking software, and in particular, to a technology making that performs corresponding fault search action and active defense action by replacing a specific memory region of a processor with a safety service module.

2. Description of the Prior Art

An active defense which is a method that predicts an incoming attack to incapacitate the attack in question, is a research which started from a national defense weapon system. Research into the active defense as a system security maintenance method against malignant code attack in web and network domain has been actively conducted in an information technology (IT) field. That is, a representative example of the active defense may include an activity searching threatening elements to a system security such as viruses and DDoS (distributed denial of service) attack by inspecting data passing through networks having reliability levels different from one another such as a network firewall, and rejecting the threatening elements.

Most researches into the active defense address issues of attack and defense between systems functionally dependent from one another. That is, when an attack from an external system which is not to be trusted is predicted or searched, and the attack is defended, the safety of an internal system may be maintained.

Meanwhile, since programs in the system may be changed, the program should be designed for programs using exceptional handling and safety code to prevent the problems as described above. However, since thorough exceptional handling of general software may impose a burden on performance of the system, balance between elements opposed to one another may not be considered.

### SUMMARY

Accordingly, the present invention provides a method and a system that checks software capable of searching fault occurrence while decreasing an interruption of a system behavior by performing the corresponding fault searching action and active defense action utilizing hooking and information tagging technologies by replacing a specific memory region of a processor with a safety service module.

In addition, the present invention provides a method and a system that checks software capable of implementing various active defense actions defined according to fault types to prevent the fault while maintaining functions of the system itself even when the fault is searched.

The present invention further provides a method and a system that checks software capable of efficiently and defensively designing a performance by supporting the active defense action for run-time defects at a kernel level managing the system, rather than at separate level for each of applications.

In addition, the present invention provides a method for checking software, the method including: hooking a process control block corresponding to a process on a kernel; obtaining execution information for an address value of the process from the PCB (printed circuit board); injecting a safety module into a memory region having an effective address value; and in when a memory region inserted with the safety service module is called during an execution of the process, searching defects of the process by the safety service module injected into the corresponding memory region.

The PCB may manage in real time process information for at least one of a name, an ID (identification), a priority, and an address value of the process, and run-time resource information for at least one of a force processor, a shared object, a file, and a mutex, in the kernel.

The injecting of the safety service module may include assigning a storage space for the safety service data and an information tag; and storing size information of the assigned storage space in a storage space of the information tag.

The method may further include providing address information of the storage space assigned with the safety service data to an execution application. The searching of the defects of the process may include checking the storage space of the information tag at the time of an occurrence of an access event in the assigned storage space; and confirming whether an access range of the access event is an effective range for the size information of the storage space stored in the information tag.

The method may further include ignoring an access of the access event when a confirmed result of the confirming of whether an access range of the access event is an effective range is not the effective range.

The method may further include adjusting the access range of the access event to the effective range when a confirmed result of the confirming of whether an access range of the access event is an effective range is not the effective range. The searching of the defects of the process may include checking the storage space of the information tag at the time of an occurrence of a release event in the assigned storage space; and confirming whether the storage space in which the release event occurs is a releasable effective address space based on the information stored in the information tag.

The method may further include performing a release event for the corresponding storage space when a confirmed result of the confirming of whether the storage space is a releasable effective address space is the effective address space.

The method may further include initializing variable assigned to the corresponding address space after the performing of the release event; performing a defense action corresponding to the defects searched in the searching of the defects of the process; performing a defense action corresponding to a type of the searched defects of an ignore action, a continue action, a warning action, a repeat action, and a terminate action.

In another aspect of the present invention, a system that checks software, may include: a hooking module that collects process control block (PCB) information corresponding to each process on a kernel by being executed at the time of booting a system; and a safety service module that searches and defends defects of the process by being injected into a memory region of the process based on the collected PCB information.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram showing a configuration of a system for checking software according to an exemplary embodiment of the present invention;

FIG. 2 is an exemplary diagram schematically showing an operation of the system checking software according to an exemplary embodiment of the present invention;

FIG. 3 is an exemplary flow chart showing an operation flow of a method for checking software according to an exemplary embodiment of the present invention;

FIG. 4 is an exemplary diagram showing a process control block (PCB) applied to an exemplary embodiment of the present invention;

FIG. 5 is an exemplary illustration diagram showing a structure of a storage space assigned with a safety service module according to an exemplary embodiment of the present invention;

FIG. 6 is an exemplary illustration diagram showing execution code of the safety service module according to an exemplary embodiment of the present invention;

FIGS. 7A to 7D are exemplary illustration diagrams showing codes applied to an exemplary embodiment of the present invention;

FIG. 8 is an exemplary illustration diagram describing an active defense operation of the system checking software according to an exemplary embodiment of the present invention; and

FIGS. 9A to 9C are exemplary illustration diagrams showing codes of each of the active defense types of the system for checking software according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, embodiments of the present invention will be described with reference to the accompanying drawings.

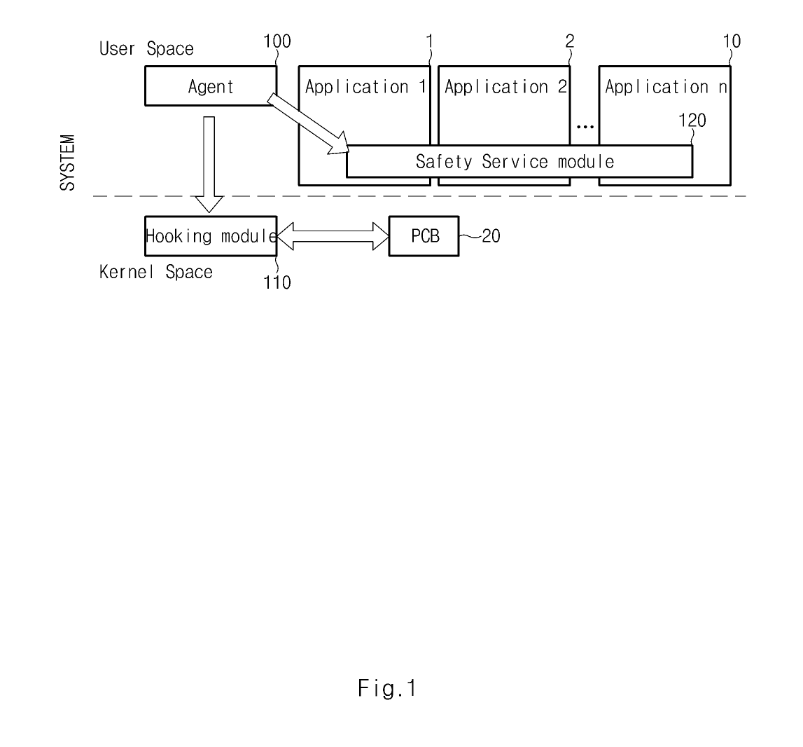

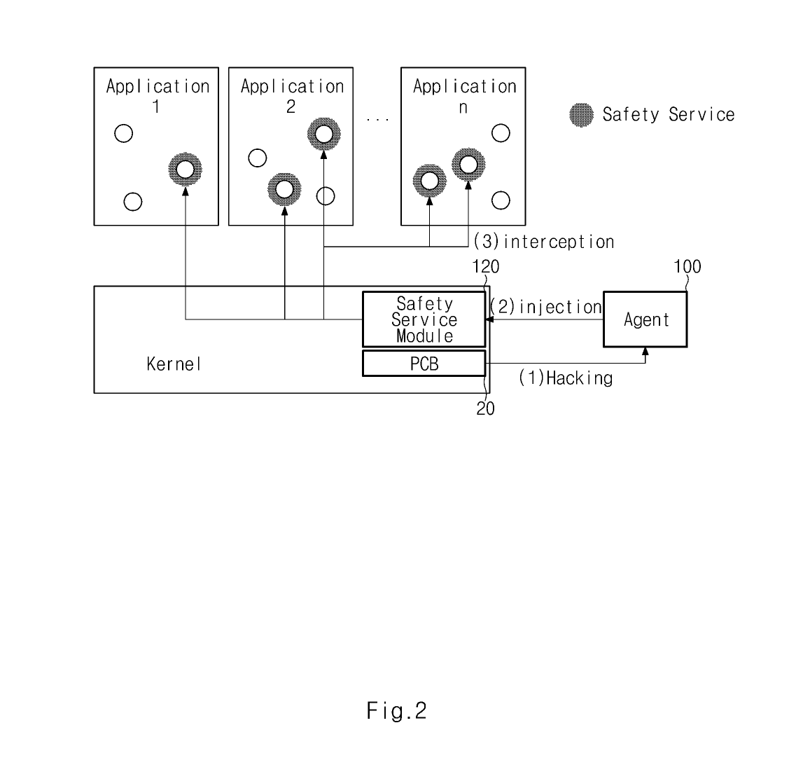

FIG. 1 is an exemplary diagram showing a configuration of a system for checking software according to the present invention and FIG. 2 is an exemplary diagram schematically showing an operation of the system checking software according to the present invention. Referring to FIGS. 1 and 2, the system for checking software may include a hooking module 110 configured to collect information for a process control block (PCB) 20 corresponding to a process of each of applications 1 to 10 by being executed at the time of booting the system and a safety service module 120 configured to search and defend fault of the process in the system by being injected into a specific memory region of the process based on the information of the collected PCB 20.

Here, an agent 100, that is, a ROPHE AD agent of the system checking software may be configured to manage the hooking module 110 and the safety service module 120. Here, the ROPHE AD, which is the acronym of ‘RemOte run-time Protection for Highrisk Error-Active Defensor’, is an automation tool operating in an embedded linux platform.

Moreover, the hooking module 110, which is a module present on a kernel, may hook the PCB 20 present on the kernel to obtain execution information for a memory region of the process. A hooking technique applied to the present invention, which is a representative technology intercepting an execution path, may be a useful method in apprehending software execution situation of the system in run-time. Therefore, the present invention may be configured to monitor a situation in which fault occurs while minimizing an interruption of a basic behavior of the system by applying the hooking technology. The hooking module 110 provides the obtained information to the agent 100 of the system for checking software, as shown in (1) of FIG. 2.

The safety service module 120 may be injected into the memory region in which the fault may arise in each process of each of the applications 1 to 10, to allow the safety service module to be replaced with a safety service routine in the corresponding memory region at the time of executing the process and is executed. In other words, the agent 100 may inject the safety module 120 into each of the applications 1 to 10 based on the PCB information hooked by the hooking module 110 as shown in (2) of FIG. 2 and intercept an attack on the process through the safety service module 120 injected into each of the applications 1 to 10 to perform an active defense as shown in (3) of FIG. 2.

In particular, the safety service module 120 injected into each of the applications 1 to 10 may include a fault searching routine that predicts a fault occurrence of the process and an active defense routine performing a defense function for each fault type. Here, the fault searching routine may determine whether an input pointer variable is an effective memory address value and the active defense routine may initiate the input pointer variable to a safe NULL value when the variable is not effective address value, thus preventing the fault occurrence.

Therefore, the safety service module 120 may be configured to perform the fault searching routine by utilizing the PCB information provided from the agent 100 and perform the active defense routine according to a result of performing the fault searching routine.

An operation flow of the system for checking software according to the exemplary embodiment of the present invention configured as described above will be described below in detail.

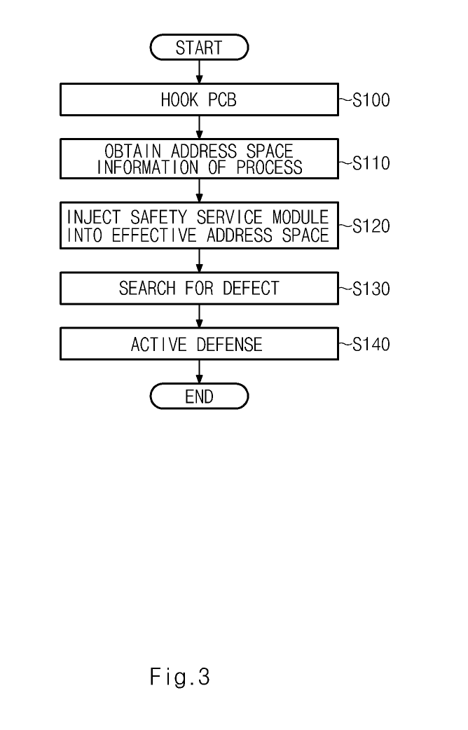

FIG. 3 is an exemplary flow chart showing an operation flow of a method for checking software of the system for checking software according to the present invention. Referring to FIG. 3, the system for checking software may be configured to hook the corresponding process control block (PCB) corresponding to the process on the kernel using the hooking module (S100) and obtain the execution information for an address space of the corresponding process from the PCB (S110). In particular, the PCB may be present on the kernel and may be configured to store process information for at least one of a name, an ID, a priority, and an address value of the corresponding process, and run-time resource information for at least one of a force processor, a sharing object, a file, and a mutex, and may manage them in real time.

Meanwhile, the system for checking software injects the safety service module into the memory region having an effective address value of the process based on the information obtained from ‘S110’ process. In particular, the injected safety service module 120 may include the fault searching routine predicting the fault occurrence of the process and the active defense routine performing the defense function for each fault type.

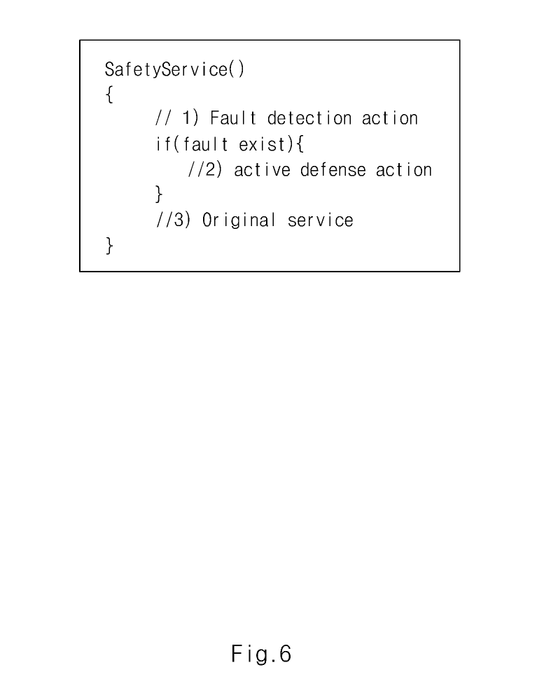

Therefore, the safety service module injected into the memory region having the effective address value of the process may be configured to perform the fault searching routine when the corresponding memory region is called at the time of executing the process and searches for the fault of the process (S130), and execute the active defense routine when the fault is searched to thereby perform the active defense for the fault of the process (5140). In particular, the fault searching routine and the active defense routine of the safety service module will be described in detail with reference to FIGS. 6 to 9C.

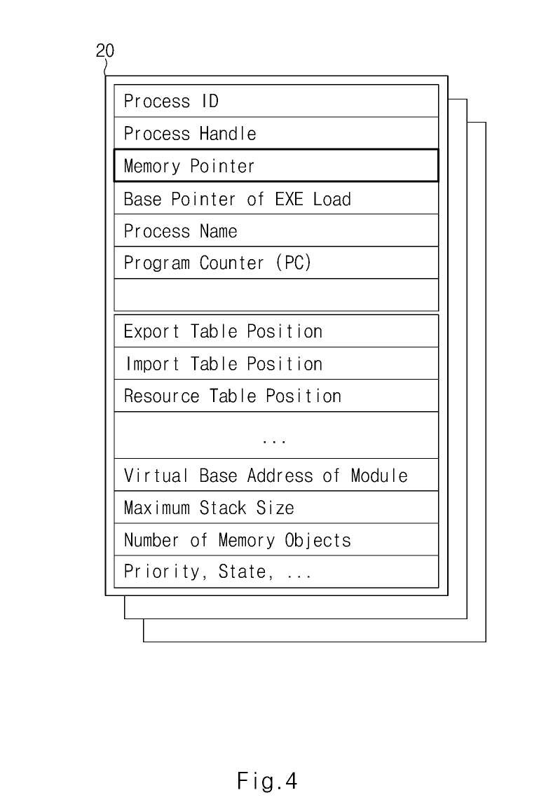

FIG. 4 is an exemplary diagram showing a process control block (PCB) applied to the present invention. As shown in FIG. 4, the PCB applied to the present invention may be configured to store the process information and the run-time resource information therein.

As an example, the PCB may be configured to store information such as a process ID, a process handle, a memory pointer, a base pointer of EXE Load, a process name, a program counter (PC), an export table position, an import table position, a resource table position, a virtual base address of module, a maximum stack size, a number of memory objects, and a priority state, and the like, in relation to the corresponding process, and manage in real time the stored information according to a state of the process.

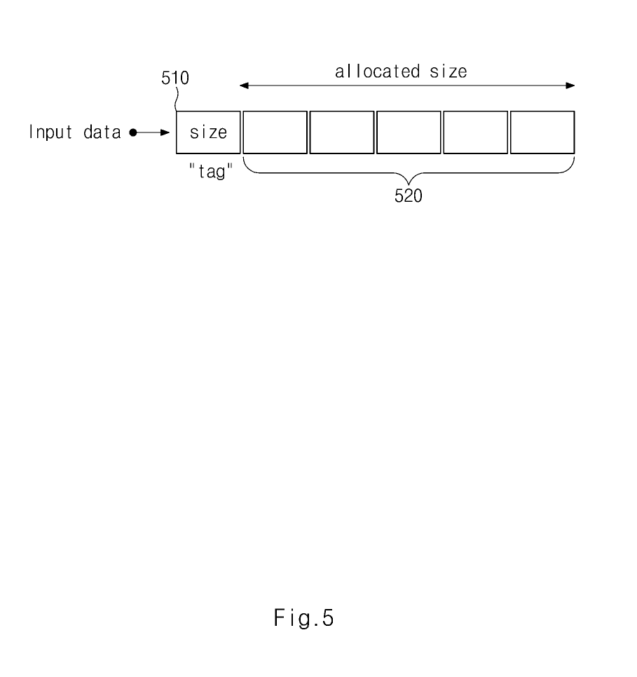

FIG. 5 is an exemplary illustration diagram showing a structure of a memory region assigned with a safety service module according to an exemplary embodiment of the present invention. When the agent of the system for checking software according to the present invention is injected into the memory region of the process, the corresponding application may be configured to assign a storage space 520 for the safety service module to the memory region of the effective address value. In particular, in addition to the safety service module, a storage space 510 of an information tag that stores the run-time execution information as well may be additionally assigned.

The storage spaces 510 and 520 assigned for the information tag and the safety service module are as shown in FIG. 5. In particular, size information of the storage space 520 assigned for the safety service module may be stored in the storage space 510 of the information tag. Specifically, the fault searching routine of the safety service module may be configured to search the fault of the corresponding memory region by determining whether the address value of the corresponding memory region is included in an effective address region using the size information of the storage space 520 stored in the information tag. Of course, the storage space 510 of the information tag may store various information by expanding the storage space according to the detect type.

However, a start address value for the storage spaces 510 and 520 assigned with the information tag and the safety service module may provide the start address value of the storage space 520 assigned with the safety service module to the corresponding application, and the information for the storage space 510 of the information tag may be a hidden space capable of being recognized only at the kernel level.

FIG. 6 is an exemplary illustration diagram showing execution code of the safety service module according to an exemplary embodiment the present invention. Referring to FIG. 6, the safety service module injected into the each application may include the fault searching routine that predicts the fault occurrence of the process and the active defense routine performing the defense function for each fault type. In particular, the safety service module may be configured to replace an address value of an original service of 3) shown in FIG. 6 with an address value of a safety service, such that the safety service may be executed when the execution of the original service of the corresponding memory region is requested.

In the case in which the safety service is executed, first, the execution code for a fault detection action of 1) is operated, and in the case in which the fault is detected by a fault detection routine, the execution code for an active defense action of 2) is operated, such that the defense for the occurring defects is performed

When the defects are not detected by the fault detection routine, the original service of 3) is executed. As an example, when the memory region including the storage space assigned with the safety service module is called by an access event, the defects searching routine may be executed, and the defect searching routine may first call and check the storage space of the information tag storing the size information for the storage space assigned with the safety service module. When, the defect searching routine may check whether an access range by the access event is an effective range based on the size information of the storage space stored in the storage space of the information tag.

Of course, when the access range by the access event is not the effective range, the active defense routine may be configured to ignore an access to the corresponding memory region or adjusts the access range to the effective range according to the situation, thereby making it possible to continue the execution. As another example, when the memory region including the storage space assigned with the safety service module is called by a release event, the defect searching routine may call the storage space of the information tag to check whether the address value of the corresponding memory region is the effective address value. When the address value of the corresponding memory region is the effective address value, the active defense routine may be configured to perform the release event for the memory region including the information tag, and may decrease an error accessing to the address value of the released memory region by initializing the corresponding variable to an NLL value.

Meanwhile, when the address value of the corresponding memory region is not the effective address value, for example, in the case in which it is an address value which is already released, the active defense routine may ignore the release event so that the system is not crashed down due to duplicated releases.

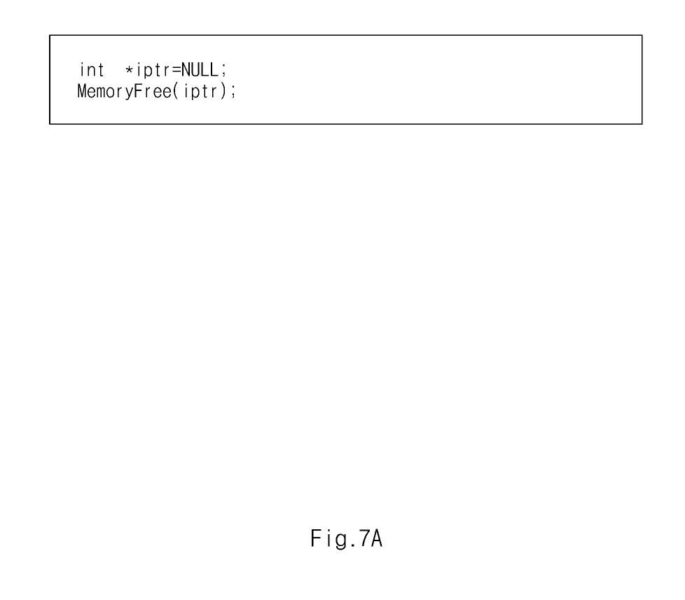

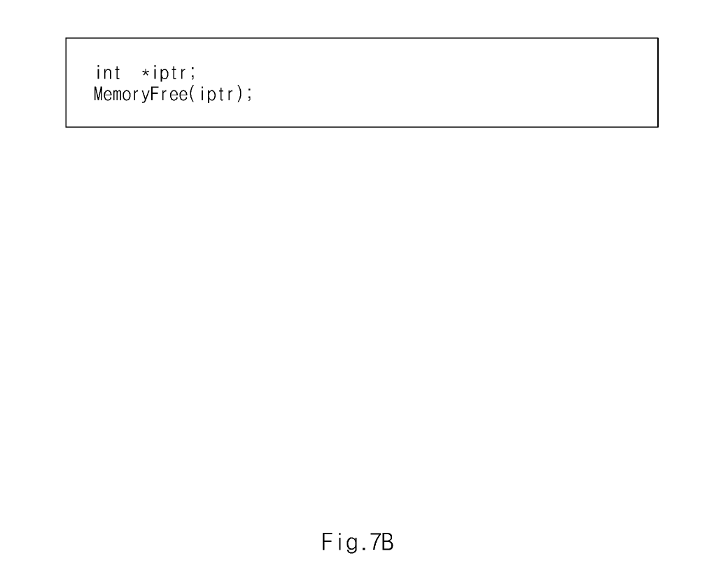

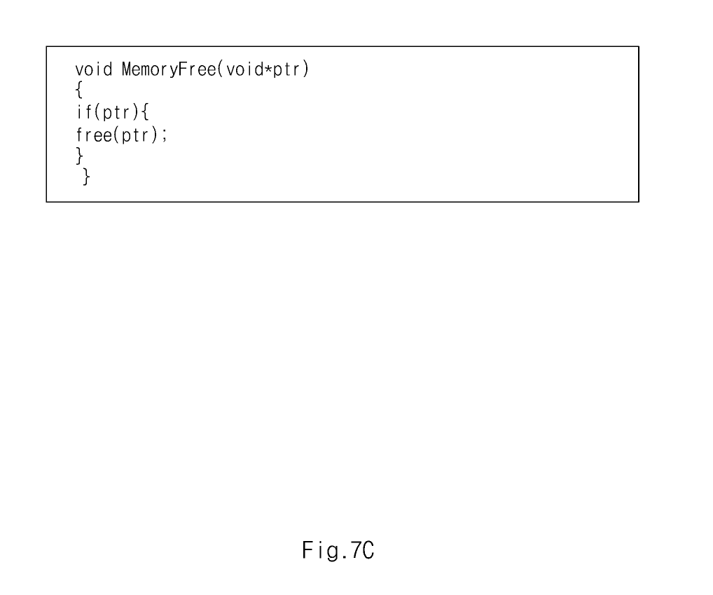

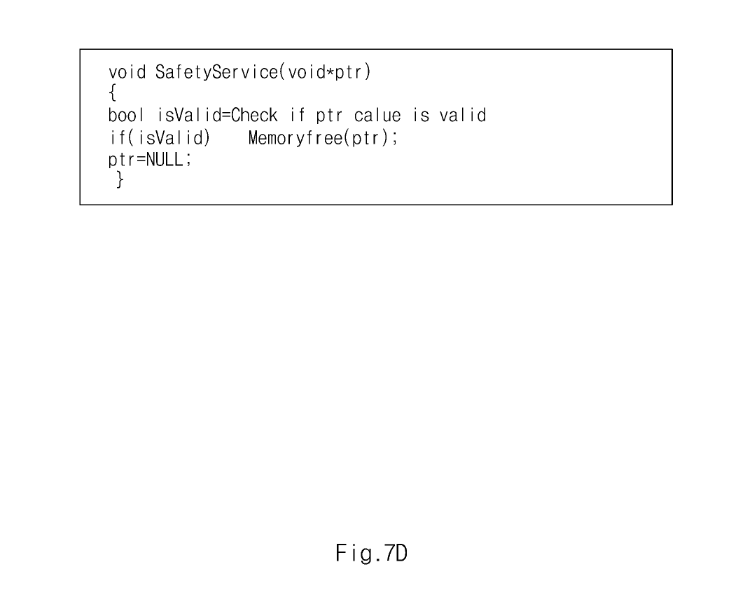

FIGS. 7A to 7D are exemplary illustration diagrams showing codes applied to an exemplary embodiment of the present invention.

First, FIG. 7A shows an exemplary embodiment when the pointer variable may be initialized to the NULL value to determine that the memory is not yet assigned to the pointer. FIG. 7B shows when having a garbage value since the pointer variable is not initialized.

Moreover, FIG. 7C shows an exemplary embodiment of a memory release code having a code checking an input value to prevent a memory defect occurrence. When the memory release code of FIG. 7C is executed, the pointer variable may be initialized to the NULL value in the embodiment shown in FIG. 7A. Therefore, when the initialized pointer variable is input, the address value of the corresponding pointer may be incorrectly recognized as the effective address to thereby make the defects. Moreover, in the embodiment shown in FIG. 7B the memory defects may be generated, since it may be difficult to determine that the pointer assigned with the memory has the effective value, when the memory release code of FIG. 7C is executed.

Therefore, the safety service shown in FIG. 7D, includes the defect searching routine that determines whether the input pointer variable is the effective memory address. When the input pointer variable is not the effective memory address, since the active defense routine initializes the pointer variable to the safe NULL value and then continues the corresponding function, the occurrence of the defects may be prevented when the memory release code of FIG. 7C is executed.

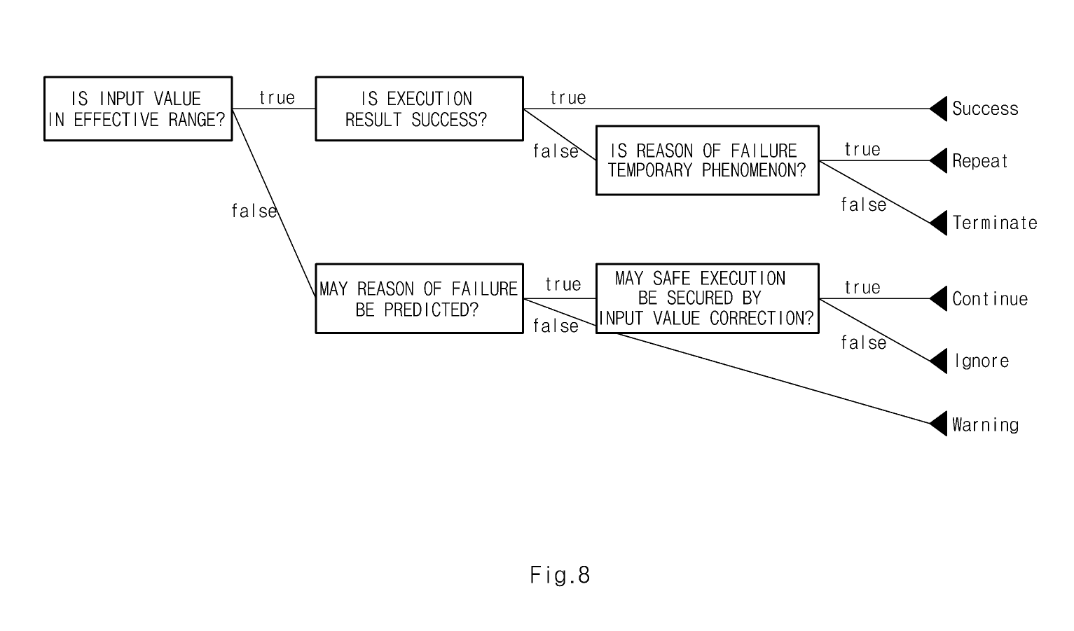

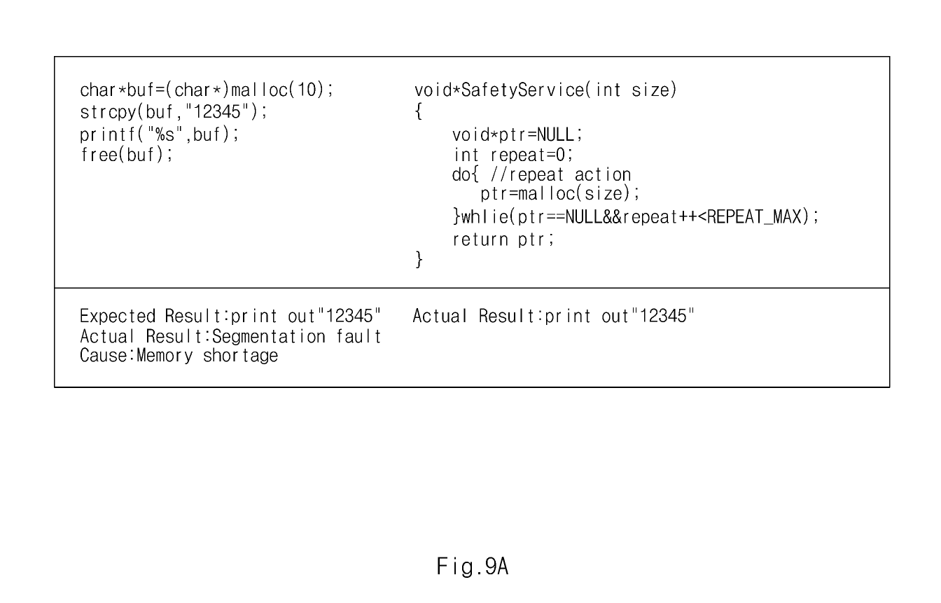

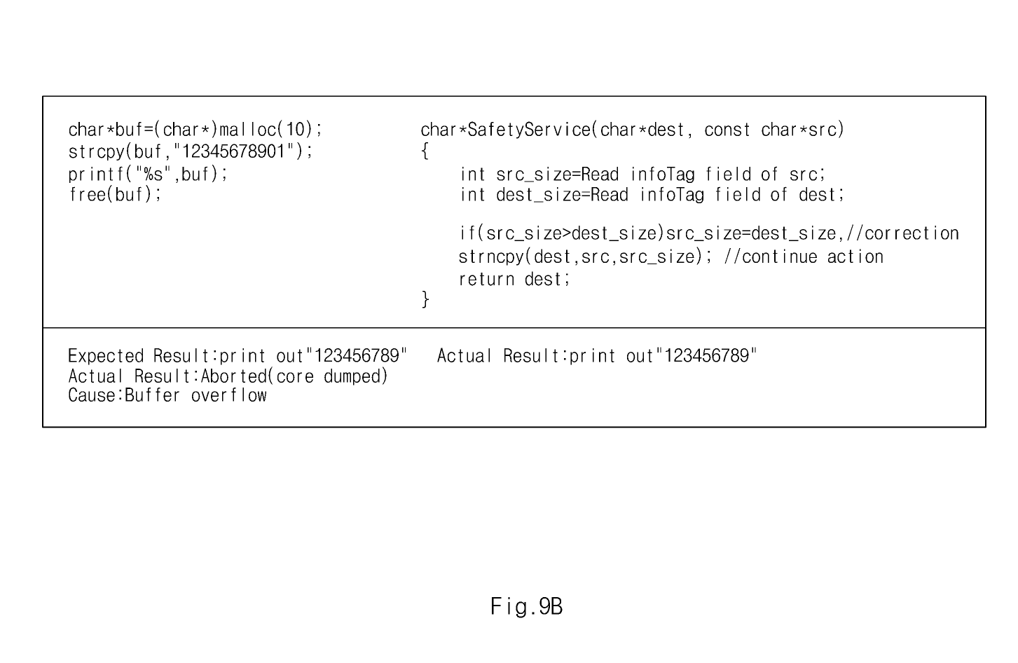

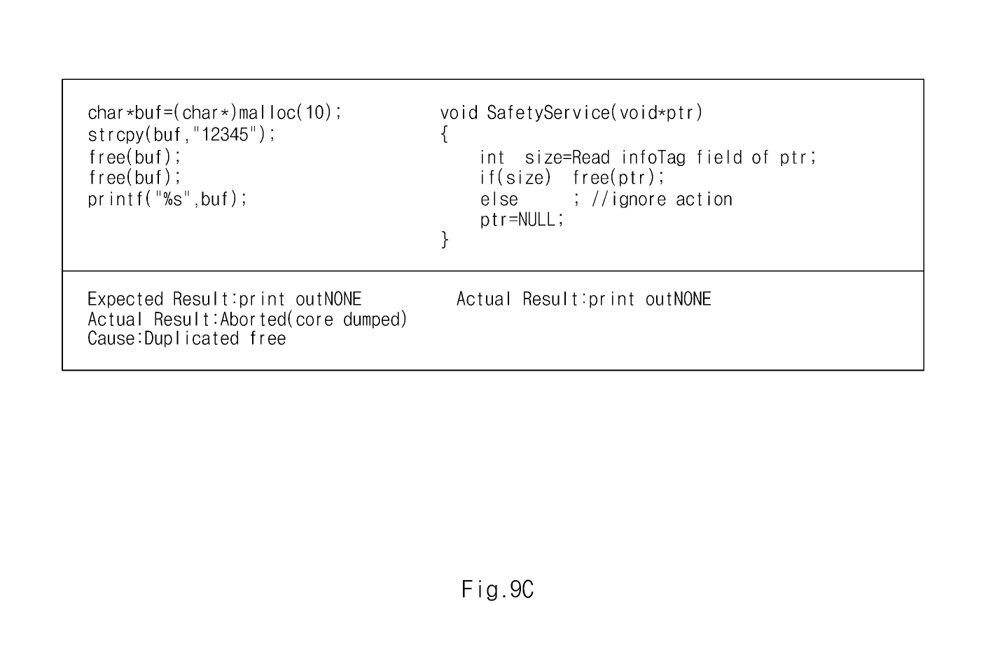

FIGS. 8 to 9C are exemplary illustration diagrams referenced in describing active defense operations of the system for checking software according to the exemplary embodiment of the present invention.

As shown in FIG. 8, the active defense routine may perform defense operations in five defense types such as an ignore type, a continue type, a warning type, a repeat type, and a terminate type according to the defect type searched by the defect searching routine. When the defects are generated in the system, the system may include input data that may not be effective data and when a system state is unstable. Therefore, the active defense routine may perform the defense in the corresponding defense type according to whether the input data is the effective data and whether the execution result is a success or failure.

As an example, when the input value is in the effective range and the execution result is the success, the active defense routine may determine that the defects are not searched and then performs a next function.

Moreover, when the input value is in the effective range, but the execution result is the failure, the active defense routine may be determined to check a reason of the failure. When the reason of the failure is due to a temporary phenomenon, the defense action corresponding to the repeat as shown in FIG. 9A may be performed.

In particular, the defense action corresponding to the repeat may be an action performed when the input value of the program is in the effective range, but an error may be temporarily generated according to the state of the system. The repeat action repeatedly may be perform the same or substantially similar event until the state of the system is returned to normal (e.g., an original state), and returns ‘fail’ to the corresponding application when continuously failing a predetermined number of times or more.

In particular, FIG. 9A shows an exemplary situation when the memory assignment may be configured to fail due to a temporary memory lack of the system. In particular, the program input may be normal as ‘12345’, but may be abnormal when a problem is generated due to a temporary system state, and the corresponding function is repeatedly attempted as much as a predefined number of times by the repeat action. That is, when the system state is in the temporary phenomenon, the system may be configured to maintain a stable operation through a few repeated executions, thereby outputting ‘12345’ as it is.

On the other hand, when the failure is not a temporary phenomenon, the defense action corresponding to the terminate action may be performed. The terminate action is an action performed when the input value of the program is in the effective range, but the error may be generated according to the state of the system and may be continuously maintained, and may be configured to terminate the corresponding process when the effect on the system by the execution result of the event is fatal.

In addition, when the input value is not in the effective range and the reason of the failure may not be predicted, the active defense routine may be configured to perform the defense action corresponding to the warning action. The warning action is an action performed when the input value of the program is not the effective value, but the reason of the failure may not be accurately inferred, and may transfer a warning message while continuously performing the corresponding event to report that the execution of the corresponding event has a problem to a user.

On the other hand, when the input value is not in the effective range and the reason of the failure may be predicted, whether or not a correction of the input value may secure safe execution is determined and when the safe execution may be secured, the continue action may be performed as shown in FIG. 9B to thereby continuously progress a next function. In particular, the continue action may be an action performed when the reason of the failure may be determined by only the input value of the program without executing the corresponding event and a normal execution may be secured by the correction of an appropriate input data value.

In particular, FIG. 9B shows a case performing a copy exceeding an effective assignment range in a function copying a character string. In particular, since an effective access range of data may be known through the information tag, the input value may be adjusted to a safe range to be copied just as much as the effective assignment range and the execution may be continued.

Moreover, when the safe execution may not be secured by the correction of the input value when the input value is not the effective value and the reason of the failure may be predicted, the defense action corresponding to the ignore action may be performed as shown in FIG. 9C. In particular, the ignore action may be an action performed in the case capable of determining that the execution of the corresponding event may cause the problem and has no effect on the next execution only using the input value of the program, and may ignore the corresponding event and immediately returns ‘fail’ to the corresponding application.

In particular, FIG. 9C shows an exemplary assigned pointer variable that performs the release operation twice, and the normal execution secured by taking the ignore action for a second release operation.

According to the present invention, a search fault occurrence may be possible while decreasing an interruption of basic behavior of a system by performing the corresponding fault searching action and active defense action utilizing hooking and information tagging technologies by replacing a specific memory region of a processor with a safety service module.

In addition, the present invention may prevent defects while maintaining an original function of the system even when the fault is searched by defining various active defense actions. Furthermore, the present invention may efficiently and defensively design a performance by supporting the active defense action for run-time faults at a kernel level managing the system, rather than at separate level for each of the applications, thereby making it possible to support reliability of equal level to all applications in the system.

Although the system and the method for checking software according to the exemplary embodiments of the present invention have been described with reference to the accompanying drawings, the present invention is not limited to the embodiments and the accompanying drawings disclosed in the present specification, but may be modified without departing from the scope and spirit of the present invention.

What is claimed is:

1. A method for checking software, the method comprising:
hooking, a process control block corresponding to a process on a kernel;
obtaining execution information for an address value of the process from the printed circuit board (PCB);
injecting a safety module into a memory region having an effective address value; and
when a memory region inserted within the safety service module is called during an execution of the process, searching defects of the process by the safety service module injected into the corresponding memory region.

2. The method according to the claim 1, wherein the PCB manages in real time process information for at least one of a name, an ID, a priority, and an address value of the process, and run-time resource information for at least one of a force processor, a shared object, a file, and a mutex, in the kernel.

3. The method according to the claim 1, wherein the injecting of the safety service module includes,
assigning a storage space for the safety service data and an information tag; and
storing size information of the assigned storage space in a storage space of the information tag.

4. The method according to claim 3, further comprising providing address information of the storage space assigned with the safety service data to an execution application.

5. The method according to claim 3, wherein the searching of the defects of the process includes,
checking the storage space of the information tag at the time of an access event in the assigned storage space; and
confirming whether an access range of the access event is an effective range for the size information of the storage space stored in the information tag.

6. The method according to claim 5, further comprising: ignoring an access of the access event when a confirmed result of the confirming of whether an access range of the access event is an effective range is not the effective range.

7. The method according to claim 5, further comprising: adjusting the access range of the access event to the effective range when a confirmed result of the confirming of whether an access range of the access event is an effective range is not the effective range.

8. The method according to claim 3, wherein the searching of the defects of the process include:
checking the storage space of the information tag at the time of an occurrence of a release event in the assigned storage space; and
confirming whether the storage space in which the release event occurs is a releasable effective address space based on the information stored in the information tag.

9. The method according to claim 8, further comprising performing a release event for the corresponding storage space when a confirmed result of the confirming of whether the storage space is a releasable effective address space is the effective address space.

10. The method according to claim 9, further comprising initializing variable assigned to the corresponding address space after the performing of the release event.

11. The method according to claim 1, further comprising performing a defense action corresponding to the defects searched in the searching of the defects of the process.

12. The method according to claim 11, wherein the performing of the defense action performs a defense action corresponding to a type of the searched defects of an ignore action, a continue action, a warning action, a repeat action, and a terminate action.

13. A system for check software, the system comprising:
a hooking module collecting process control block (PCB) information corresponding to each process on a kernel by being executed at the time of booting a system; and
a safety service module that searches and defends defects of the process by being injected into a memory region of the process based on the collected PCB information.

14. The system according to claim 13, wherein the PCB manages in real time process information for at least one of a name, an ID, a priority, and an address value of the process, and run-time resource information for at least one of a force processor, a shared object, a file, and a mutex, in the kernel.

15. The system according to claim 13, wherein the safety service module includes a defect searching routine and an active defense routine.

16. The system according to the claim 15, wherein the defect searching routine confirms an effective range or an effective address value using an information tag assigned to the memory region, and searches the defects of the process for an input event according to the confirmed result.

17. The system according to claim 15, wherein the active defense routine defines a defense action for at least one of an ignore action, a continue action, a warning action, a repeat action, and a terminate action, and performs the defense action corresponding to a defect type searched by the defect searching routine of the defined defense actions.
